(19) United States
(12) Patent Application Publication
(10) Pub. No.: US 2002/0129276 A1
(43) Pub. Date: Sep. 12, 2002

(54) Dual network with distributed firewall for network security

(76) Inventor: Michael P.C. Watts, Portola Valley, CA (US)

Correspondence Address: Michael P.C. Watts, 1185 Los Trancos Road, Portola Valley, CA, 94028, US

(21) Appl. No.: 09/802,710

(22) Filed: Mar. 8, 2001

(51) Int. Cl. H04L 9/00; G06F 15/173

(52) U.S. Cl. 713/201; 709/223

(57) ABSTRACT

The invention provides for remote access by remote users on a public network such as the Internet to a private network (or Host network) node without compromising the Host network security. Remote access is provided by a second network (or Access network) separate from the Host network but under the control of the Host network. Nodes that are required to support remote access are connected to both the Host and Access network by an electrical switch controlled by the Host network. Typically the Host and Access networks have their own connections to the public network and each node has two identification codes or IP addresses. There are two physically separate paths for packets of data to reach a node from a public network.

### BACKGROUND TO THE INVENTION

1. Field of the Invention

The present invention relates generally to firewalls for the protection of private networks of computers an computer controlled equipment that are connected to public networks of computers. In particular the present invention is directed to ensuring private network security while remote users on a public network upload or download data to nodes on the private network. The invention is designed to allow remote access to individual computers and computer interfaced equipment on a private network without compromising security of the private network.

2. Description of the Background

The typical firewall is designed to operate in an environment in which information passes between a remote user on a public network and a node on a private network. A node will typically be a computer or a piece of computer controlled equipment. The typical node divides the information to be sent into packets of data and the typical network connection switches the packets to the correct node using the network identification code of the node. The network identification code is usually the IP address. The route from remote user to target node can involve numerous links over numerous networks. Typical networks are described in “Step up to Networking” by J Woodcock and published by Microsoft Press. Network security is discussed in “Mastering Networking Security” by C Benton and published by Sybex.

There are two methods of passing packets over networks using either a connectionless or a connection oriented communication service. In a connectionless service, each packet is an independent unit that can take its own route to the target node. In a connection oriented service, a route is chosen and maintained until all the packets in the entire message has been sent, although multiple packets travelling to multiple locations can share steps in their routes. The process of passing packets is accomplished by network protocols such as Ethernet which is a connection less protocol and Asynchronous Transfer Mode (ATM) which is a connection oriented protocol. These protocols are usually described in terms of a model consisting of layers that manage different parts of the communications process. The 7 layers in the OSI model are described in “Step up to Networking” p 67. The layer 1 in the communication process is the physical layer of electrical or optical binary signals. The layer 2 is the data link layer that ensures reliable passing of packets from source to destination on a single step in the route. The layer 3 is the Network layer that routes the packets over multiple steps to their final destination.

The typical firewall is placed at the point of connection between the private network within a home or corporation and the public network such as the Internet. The functions of a typical firewall include hiding details of the internal structure of the private network, preventing unauthorized entry, checking for viruses hidden in emails or blocks of downloaded data, and blocking damaging commands. Some firewalls provide an encryption barrier to enhance security of the private network.

There are a number of limitations to typical firewalls. A remote user who finds a way past the firewall at the entry point to the private network has complete access to the private network. People who find a way past the firewall with intent to do damage can be hackers, or disgruntled individuals with valid encryption keys. Once past the firewall, the only way to limit access within a private network is by separating the network into sub networks separated by routers. Routers make decisions to pass the packets of data between computers based on the identification codes of both send and receive computers. There are ways to deliberately disguise the identification code of the sender and bypass the routers security as discussed in “Mastering Networking Security”.

An additional limitation of typical firewalls arises from the difficulty of checking that all the incoming information to a large commercial network only contains acceptable commands and data. The difficulty in checking for acceptable content is mostly due to the unlimited number of programs that can be used to generate the information. Because the firewall cannot check that the incoming information is acceptable, the typical firewall attempts to check for damaging programs such as computer viruses. Checking for viruses is a continuous problem because the inventor of a new virus will typically be able to beat a trapping program designed for known viruses.

The typical firewall has particular difficulty with respect to two trends in the Internet; entertainment and remote diagnostics. With the Internet as a source of entertainment, large amounts of video will be sent into the private network in the home. This data will probably not be uniquely encrypted for each user, and will be very difficult to check for viruses because of the amount of data.

Remote diagnosis describes a process for identifying the cause of a problem in a computer or a piece of computer controlled equipment and solving the problem from a remote location. With more equipment being computer controlled there are opportunities to diagnose problems, and service the equipment over the Internet without sending a service person. The problem is that to diagnose a problem the remote user needs complete access to the equipment which presents several security dangers to the equipment and the private network. One danger is that the remote user must have unrestricted access to the equipment and will be difficult to block from the rest of the network.

The equipment vendor also has concerns because to diagnose problems typically requires a much greater level of detailed knowledge than is usually provided in a manual. Typically the vendor does not want to disclose all the proprietary internal detail of their equipment to their customer, so each vendor would prefer to keep their data away from the customers private network and keep competitors from spying on the equipment while performing maintenance on their own equipment.

The present invention is particularly suited to providing security when user is receiving a large amount of unencrypted data such as a movie being downloaded. The present invention also provides security when remote users are reading the data inside computer controlled equipment to diagnose problems.

### SUMMARY OF THE INVENTION

The invention provides for remote access by remote users on a public network such as the Internet to a private network (or Host network) node without compromising the Host network security. Remote access is provided by a second network (or Access network) separate from the Host network but under the control of the Host network. Nodes that are required to support remote access are connected to both the Host and Access network by an electrical switch controlled by the Host network. Typically the Host and Access networks have their own connections to the public network and each node has two identification codes or IP addresses. There are two physically separate paths for packets of data to reach a node from a public network.

The invention provides security for the Host network connected to a public network such as the Internet using a electrical switch and a firewall associated with each node. The electrical switch is an EITHER-OR switch controlled by the Host network, which ensures that any node being accessed from outside is disconnected from the internal network by a physical hardware switch. The advantage of a hardware switch or electrical switch as compared to a conventional packet switch in a typical router is that the electrical switch cannot be disabled or bypassed by an external piece of software.

Firewalls at each node are distributed throughout the private networks allowing content checking and encryption of information unique to individual nodes. By having the firewalls distributed at each node, the information can be checked against the limited instruction set unique to that node, so the firewall provides a positive check for acceptable content.

The two private networks pass messages over two different media where the different media are two separate cables, two separate groups of wires in a single cable, one wired media and one wireless media, or two different protocols running in a common wire. The use of two media ensures that one set of messages on the access network cannot be sent over the private network either by a mistake or by an unauthorized intruder.

The switch box can be implemented in several ways such as part of a hub in a star topology network, or using external switch boxes that connect the node to the networks, or with the switch box built into the node.

### BRIEF DESCRIPTION OF THE DRAWINGS

The accompanying drawings, which as incorporated in and constitute part of this specification, illustrate embodiments of the invention and, together with the description, serve to explain the advantages and principles of the invention. In the drawings,

FIG. 1 is a block diagram of the dual network

FIG. 2a is a block diagram of a hub network with a separate switch

FIG. 2b is a block diagram of a hub network with a switch built into a node

FIG. 2c is a block diagram of a hub network with a switch built into hub

FIG. 3 is a block diagram of an dual network switch

FIG. 4 is a block diagram of a hub network with a multiple protocol switch

FIG. 5 is a method for remote access

### DETAILED DESCRIPTION

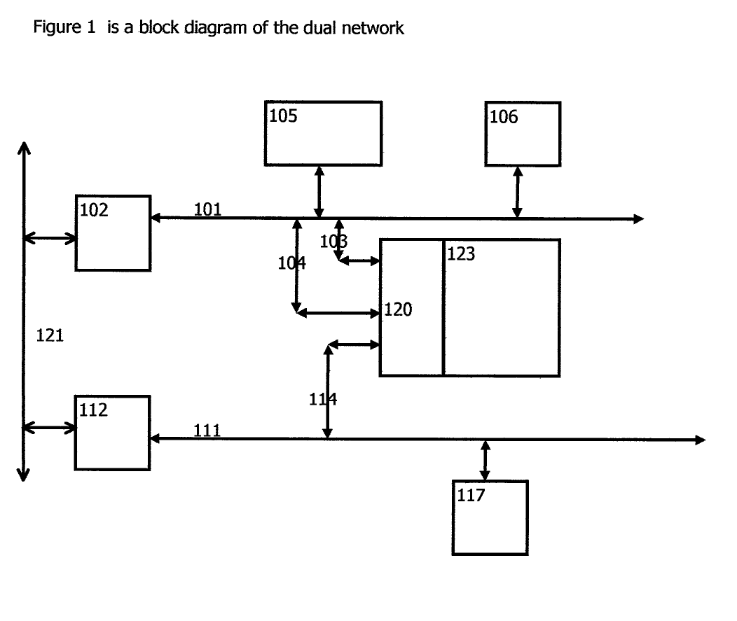

The preferred embodiment of the network architecture is shown in FIG. 1, consisting of two private networks 101 and 111 connecting a node 123 to both private networks through a switch box 120 . Each network is connected to a public network 121 such as the Internet through routers 102 and 112. For the purpose of illustration, the network 101 is designated as the “Host Network”, and it is assumed that the Host Network is used for inter computer communications, printing and all the normal traffic associated with a network within a company or a home.

Again for the purpose of illustration, the private network 111 is designated as the “Access Network”, and it is assumed that the Access Network is used for the high bandwidth input and output that is associated with entertainment or remote diagnosis. It will be obvious to someone skilled in the art, that the single networks 101 and 111 may be multiple networks connected by hubs and routers distributed anywhere in the world or in space and that there can be multiple switches and nodes connected to the networks.

The switch box 120 has a connection 103 for the Host Network 101 to pass data, a connection 114 for the Access Network 111 to pass data, and a connection 104 to the electrical switch 120 inside the switch box. Computer 105 uses the connection 104 to control which network (either 101 or 111) is connected to the node 123. A computer 117 on the Access Network is used to log all activity on the Access Network.

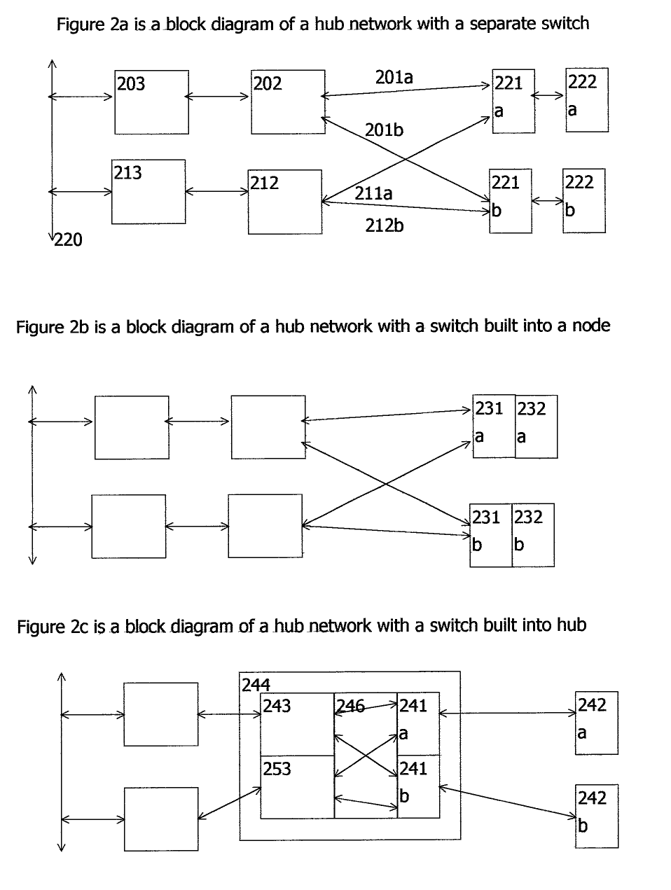

The preferred embodiment for the connection of the node with a separate switch box is shown in FIG. 2a. One node 222a is connected to a switch box 221a which is connected to a hub 202 by media 201a, and a second node 222b is connected to switch box 221b which is connected to the hub 202 by media 201b. The hub allows multiple nodes such as computers and computer controlled equipment to form a network connection and communicate. The hub 202 is connected to the public network 220 by a router 203. A second hub 212 provides a second connection 211a and 211b to the nodes. The second hub 212 has a second connection the public network 220 though a router 213.

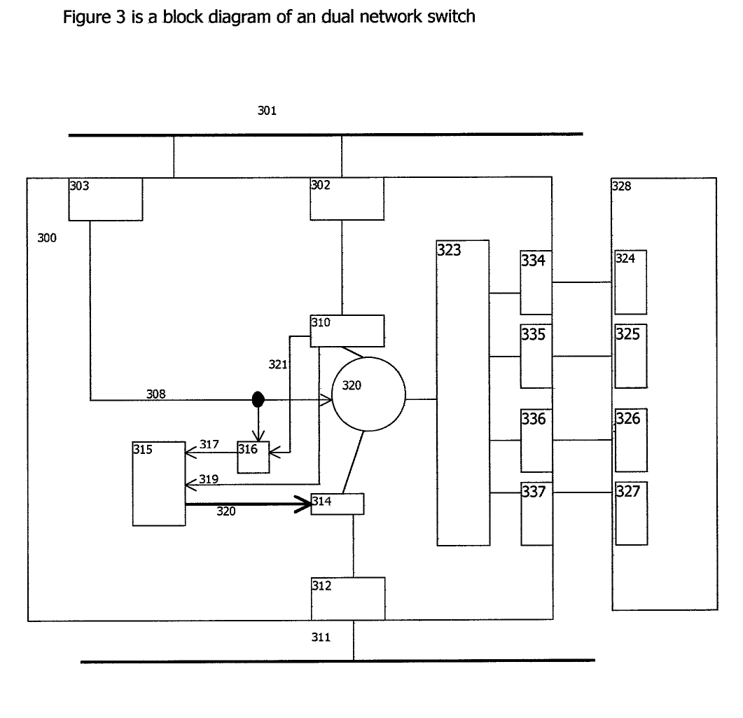

FIG. 3 shows the detailed design of the preferred embodiment of the switch box 300 connecting the Host Network 301 and the Access Network 311 to the node 328 that has a network connection 324 that is typically an Ethernet connection. The switch box 300 has 4 network connections. The first is a network connection 334 to the node. The second is a network connection 312 for data transfer with the Access Network. The third is a network connection 302 for data transfer with the Host Network. The fourth isa network connection 303 for the control of the switch box 300 through the Host Network.

The switch 320 determines whether the data packets pass back and forth from Host Network connection 302 or the Access Network connection 312 to the node network connection 334. The switch 320 is controlled by the switch enable line 308 from the Host Network connection 303 that sets the switch enable line 308 to a high or low value.

When the Access Network is connected, data packets pass back and forth from the Access Network connection 312 to the node network connection 334 via the firewall 314, the switch 320, and the I/O manager 323. The firewall 314 implements functions such as decryption and encryption, user authentication, content checks and virus checks. The I/O Manager 323 coordinates data from multiple ports 325, 326 and 327 on the equipment and which enters the switch box though ports 335, 336 and 337. The additional equipment ports 325, 326 and 327 are debug ports that can be different network connections, digital or analog I/O ports which give the service person access to the equipment that is not normally available to the customer. The I/O manager also supplies information on the data being passed over the Access Network to the computer 117 in FIG. 1. The computer 117 is used to log all activity on the Access Network.

The firewall 314 uses firewall data read from memory 315 over the read data lines 320. The firewall data read from memory 315 includes security keys that decode input and convert it to readable data using the security keys and take output and convert it to encoded output using the security keys Additional firewall data are used in a checklist for acceptable content such as function names, number of arguments argument type, data format, and data. Addition firewall data includes the identification of the authorized remote user.

When the Host Network is connected, data packets pass back and forth from the Host Network connection 302 to the node network connection 334 via the firewall manager 310, the switch 320, and the I/O manager 323. The firewall manager 310 is responsible for receiving the firewall data sent to the switch box 300 from the Host Network, and writing the firewall data into memory 315 over lines 319. The write enable lines for the memory 317 are set by the AND block 316 that combines the write enable line from the firewall manager 310 and the switch enable line 308 which ensures that firewall memory cannot be written while the Access Network is connected. The location of the firewall manager between the switch 320 and the Host Network ensures that the firewall data can only be received from the Host Network.

In the preferred implementation, the blocks in the switch box 300 are implemented as combinations of integrated circuit chips.

In the preferred implementation, the two networks 101 and 102, are physically connected through a single RJ45 5 pin connector which is the standard Ethernet connector in which only 2 of the 5 lines are used. The advantage of using a single connector is that there is no chance that the Host network is plugged into the Access network port.

There are alternate implementations of the network layout, switch box, network connectors, and network media that are disclosed below.

An alternative network layout is shown in FIG. 2b in which the switch boxes 231a and 231b are built into the nodes 232a and 232b which has the advantage to the vendor of the node of selling an integrated solution.

Another alternative network layout is shown in FIG. 2c in which the switch box 24a and 241b is built into a hub assembly 244 which has the advantage that the solution can be implemented by simply replacing a hub with no new connections being made cut to the node. The node 242a and 242b has single connections to the switch boxes 241a and 241b. There is a connection matrix 246 that connects the switch boxes to the hubs 243 and 253.

An alternative embodiment of the physical connection of the network to the switch box is to use a different connector and cable style for the two networks such as RJ45 for one network and Coax plug for the other network, or have one of the two networks be wireless, or having one network connected through a phone line and the other network through a cable television connection, or have two nominally identical connectors with mechanical keys to ensure they are plugged in correctly. The physical connections of the two networks are made mechanically distinct to eliminate the chance of incorrect connections.

An alternative embodiment of the switch box and equipment includes a separate status port on the node connected to the network connection 303 in FIG. 3 that allows the status of the equipment to be read at all time by computers on the Host Network. Another embodiment of the switch box includes a firewall on the Host network side of the switch box.

Alternative embodiments of the firewall can eliminate parts of the content checking and virus checking functions, or can expand these functions.

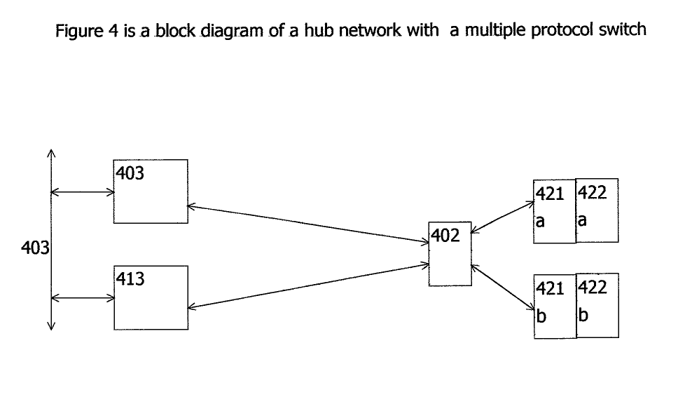

An alternative implementation of network architecture uses different network protocols to keep the Host and Access networks physically separated a shown in FIG. 4. There are two routers 403 and 413. The protocol for each router uses the same physical layer 1 and data layer 2 but use different network layer 3 or higher to pass packets. These layers are part of the OSI reference model for network communications. The routers 403 and 413 are connected to the hub 402 along with the switch boxes 421a and 42lb built into the nodes 422a and 422b. The switch boxes built into the equipment have network connections that read and write one protocol and ignore the other protocol. As a result the data packets on the Host and Access Networks are kept separate as if they were passing down separate wires. A network architecture with 2 protocols is relatively to install. The addition of a router 413 with a different protocol can provide secure remote access to any node on the Host network that has a switch box.

There are alternate implementations of the switch 320 for applications that include nodes that have limited input or output capability. Examples of nodes have limited input or output capability include displays, printers and cameras. When the nodes has limited input or output capability, the switch can turn the access network or the host network on and off independently.

In another implementation, the switch box 300 can be replaced with a single network interface that can be reconfigured to accept a different protocol. In another implementation the switch box 300 can be a packet switch.

Alternative implementations of the blocks in the switch box use one or more custom integrated circuits or use a general purpose processor and software.

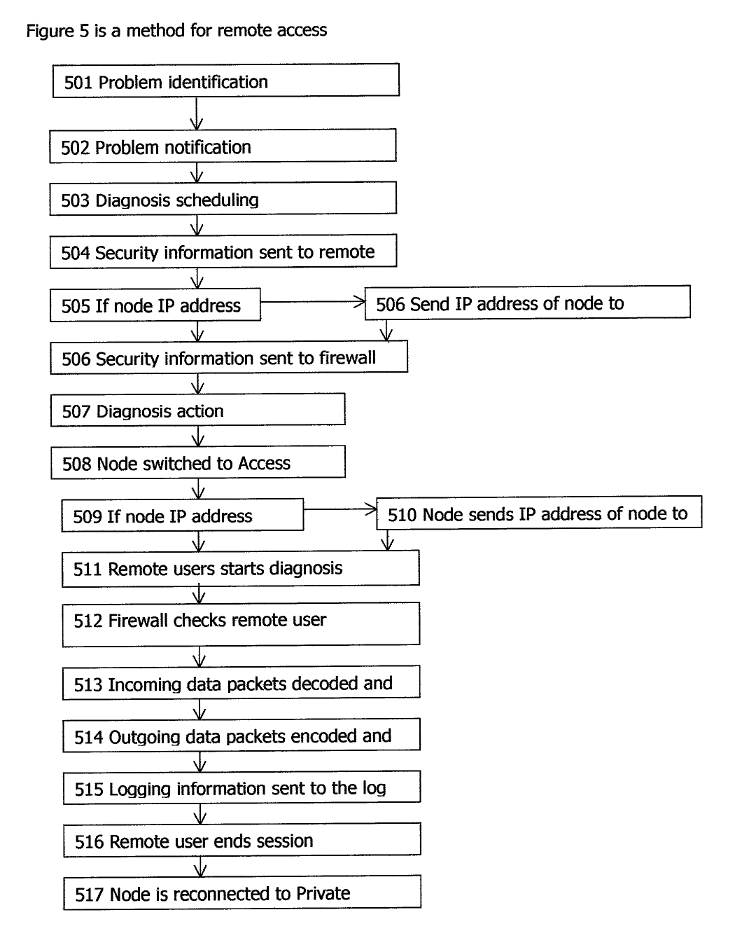

In the preferred embodiment, remote diagnosis is accomplished with the steps shown in FIG. 5. The first step 501 comprises problem identification by a user or by the node. The next step 502 comprises notification to the network server that there is a problem with a node.

After evaluation by system administrator, diagnosis 503 is scheduled with the remote user who will conduct the diagnosis. In an emergency, scheduling may be automatic and immediate. Next 504 the network server sends security information such as security keys over the Host and Public Networks to the remote user. Then 505, if the node IP address is fixed, the network server supplies 506 node identification including the IP address to the remote user. Then 506 the network supplies security information such as security keys, content check, user identification and virus check data to the firewall memory 315 in FIG. 3.

At the scheduled time diagnosis starts 507. The network server switches 508 the node to the Access Network. If the node IP address is dynamically assigned 509 then the node supplies 510 IP address to the vendor over the Access and Public Networks. The remote user makes contact with the node and runs 511 the diagnostic session. The firewall checks 512 that users identification is authorized by checking the list in the firewall memory. During the diagnosis 513 and 514, data packets from the vendor are decrypted, content checked and virus checked. Data packet information is sent 515 by the IO manager in the switch box to the Access Network log computer. The remote user notifies 516. the network server that the session has ended over the Host and Public Networks or through the status port on the equipment. Finally the network server switches 517 the node to the Host Network.

In alternative implementations, the switch box is used to support the supply of entertainment to a TV on the Host Network. The TV system consists of three nodes, a display and a controller and optionally a video recorder, each with its own network connection. The display and video recorder have a switch box so they can be connected to the Access network. The controller acts as the network server 105 that schedules the switching of the display and recorder, or communicates with a separate network server. The user interacts with the controller to select a movie over the Host and Public Network. The movie is sent to the display or video recorder over the Access Network. The switch box can also include a Internet browser for displaying downloaded Internet data without storing the downloaded data or any hidden viruses.

In another implementation, the display has multiple inputs including 2 network connections and the different inputs appears as different windows in the display. The display is configured as a input only device and cannot be used to access the rest of the Host network so the display does not need a switch box.

In another implementation, the switch box is used to support remote access to video cameras used for surveillance. The camera has multiple outputs including 2 network connections. The camera is essentially an input only device and cannot be used to access the rest of the Host network so the camera does not need a switch box. When the camera or the network server identifies a problem the event is recorded on a video recorder that does have a switch box as it can both input and output video. A message and a copy of the video is sent by email or telephone to a remote user responsible for security. The remote user connects via the Public and Host networks and connects with the cameras over the Access network. The remote user live video to determine the appropriate action while the video is also being recorded over the Host network.

The foregoing description of an implementation of the invention has been presented for the purposes of illustration and description. It is not exhaustive and does not limit the invention to the precise form disclosed. 16We

We claim:

1 A network security apparatus comprising:
a plurality of private networks with routers to external networks; and
a plurality of switch boxes connecting said private networks to a plurality of network enabled nodes; and
said switch box comprising a switch that controls which of said private networks is connected to said plurality of nodes.

2 The apparatus of claim 1 wherein said switch is controlled by one of said private networks.

3 The apparatus of claim 1 wherein said switch box is built into said node.

4 The apparatus of claim 1 wherein said plurality of switch boxes are built into a hub used to connect a plurality of nodes.

5 The apparatus of claim 1 wherein said switch box is located between a hub used to connect a plurality of nodes and the said node.

6 The apparatus of claim 1 wherein said switch controls which of two private networks is connected to said node.

7 The apparatus of claim 2 wherein said private network that controls switch comprises a node that controls switch.

8 The apparatus of claim 1 wherein said switch box additionally comprises a firewall.

9 The apparatus of claim 8 wherein said switch box additionally comprises memory readable by said firewall

10 The apparatus of claim 9 wherein said switch box comprises a memory write control that comprises an AND function with the electrical signal that enables said switch to connect said controlling network to said node.

11 The apparatus of claim 1 wherein said switch box comprises connection with a plurality of electrical signals within the node.

12 The apparatus of claim 7 wherein said plurality of private networks comprises a node for recording logging information.

13 The apparatus of claim 1 wherein the plurality of private networks operate on a plurality of media.

14 The apparatus of claim 13 wherein said plurality of media comprises different protocols operating over said plurality of private networks.

15 The apparatus of claim 1 wherein said switch box is reconfigurable to support different protocols.

16 The apparatus of claim 1 wherein said plurality of nodes essentially only receive data and are connected to said plurality networks simultaneously.

17 The apparatus of claim 1 wherein said plurality of nodes essentially only send data and are connected to said plurality networks simultaneously.

18 A method of ensuring network security comprising the steps of:
notifying a node on a first private network of the need to access a plurality of nodes from a node on a public network; and
said notified node supplying security information about said plurality of nodes to said public node; and
said notified node supplying security information about said public node to said plurality of nodes; and
said notified node switching said plurality of nodes to a second private network; and
said public node sending and receiving information with said plurality of nodes; and
said notified node switching said plurality of nodes to a said first private network.

19 The method of claim 18 wherein said plurality of nodes send security information to said public node after switch has been changed to said second private network.

20 The method of claim 18 wherein said sent and received security information passes through a firewall in said switch and said node supplying information supplies firewall check list to firewall readable memory.

21 The method of claim 18 wherein said sending and receiving information passing between the public and private networks comprises the steps of:
sending and receiving information at said routers with a plurality of protocols; and
passing information between said routers and said nodes over a single media; and
sending and receiving information at said nodes with a plurality of protocols.

22 A network security apparatus comprising:
a means for connecting a plurality of public network connected private networks to a plurality of nodes; and
a means for switching one of said private networks to one or more of said nodes; and
a means for checking data packets passing from said public network to said nodes.

23 A network security apparatus comprising:
a plurality of private networks with routers to external networks; and
a plurality of switch boxes connecting said private networks to a plurality of network enabled nodes; and
said switch box comprising a switch that determines which network is connected to which nodes; and
said switch controlled by a computer on one of said plurality of networks; and
said switch box comprising a firewall; and
said switch box comprising memory read by said firewall; and
said memory written by said switch controlling computer.

24 The apparatus of claim 23 additionally comprising said plurality of networks operating over a single media using a plurality of network protocols.
